(19) United States
(12) Patent Application Publication
(10) Pub. No.: US 2007/0081362 A1
(43) Pub. Date: Apr. 12, 2007

(54) Christmas ornament

(76) Inventor: Ling-Yung Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/204,313

(22) Filed: Aug. 16, 2005

(51) Int. Cl. H01R 33/00

(52) U.S. Cl. 362/654

(57) ABSTRACT

A Christmas ornament can be assembled with an illuminating device easily therein and provide color-transforming effectiveness with a well mixed and gradual-layers light appearance. The Christmas ornament has a housing and an illuminating device. The housing has a plurality of peripheral walls and a bottom wall. The peripheral walls are made of semitranslucent material and the bottom wall is fixed on a bottom of the peripheral walls. The illuminating device has a light seat fixed on the bottom wall, a plurality of light sources fixed on the light seat and a control unit received in the light seat. The light sources are divided into at least two color groups, and the control unit is electrically connecting the light sources for controlling the color groups to illuminate according to a predetermined sequence.

### BACKGROUND OF THE INVENTION

1. Field of the Invention The present invention relates in general to a Christmas ornament, which has a plurality of light sources and the light sources can change light colors by turns.

2. Description of the Prior Art

There are many types of Christmas ornaments, including lighted ornaments. One type of ornament is a wire frame gift box, which is usually used for outdoor decorations. The wire frame of the gift box is connected with a plurality of bulbs for providing illuminating decoration. The wire frame also can be shaped in other types of sculptures. However, the above-mentioned conventional ornaments have a light appearance of dot-shape lights. These types of ornaments usually cannot provide an even (well-mixed) light effectiveness, i.e. cannot mix different color lights well.

One another type of ornament, such as a cloth gift box or a small Christmas tree, which is assembled with a light string in a hollow housing thereof, and the light string connects with a plurality of bulbs. Besides the problem above-mentioned, this type of conventional ornament has another problem that is assembly inconvenient. The light string is not easily to fix in the housing, because the housing of small Christmas tree is narrow and long. Therefore, it is usually hard to assemble a long light string into the housing

### SUMMARY OF THE INVENTION

The present invention provides a Christmas ornament, which is assembled with a plurality of light sources of different colors and can provide color-transforming effectiveness with a well-mixed and gradual-layer light appearance.

The present invention provides a Christmas ornament, which can be assembled with an illuminating device easily therein.

In order to achieve the above objectives, the present invention provides a Christmas ornament having a housing and an illuminating device. The housing has a plurality of peripheral walls and a bottom wall. The peripheral walls are made of semitranslucent material and the bottom wall is fixed on a bottom of the peripheral walls. The illuminating device has a light seat fixed on the bottom wall, a plurality of light sources fixed on the light seat and a control unit received in the light seat. The light sources are divided into at least two color groups, and the control unit is electrically connecting the light sources for controlling the color groups to illuminate according to a predetermined sequence.

### BRIEF DESCRIPTION OF THE DRAWINGS

The invention will be better understood and objectives other than those set forth above will become apparent when consideration is given to the following detailed description thereof. Such description makes reference to the attached drawings, wherein:

FIG. 1 is a perspective view of a Christmas ornament of first embodiment according to the present invention,

FIG. 2 is a perspective view of a Christmas ornament of second embodiment according to the present invention;

FIG. 3 is a perspective view of a Christmas ornament of third embodiment according to the present invention; and

FIG. 4 is a perspective view of a Christmas ornament of fourth embodiment according to the present invention.

### DETAILED DESCRIPTION OF PREFERRED EMBODIMENTS

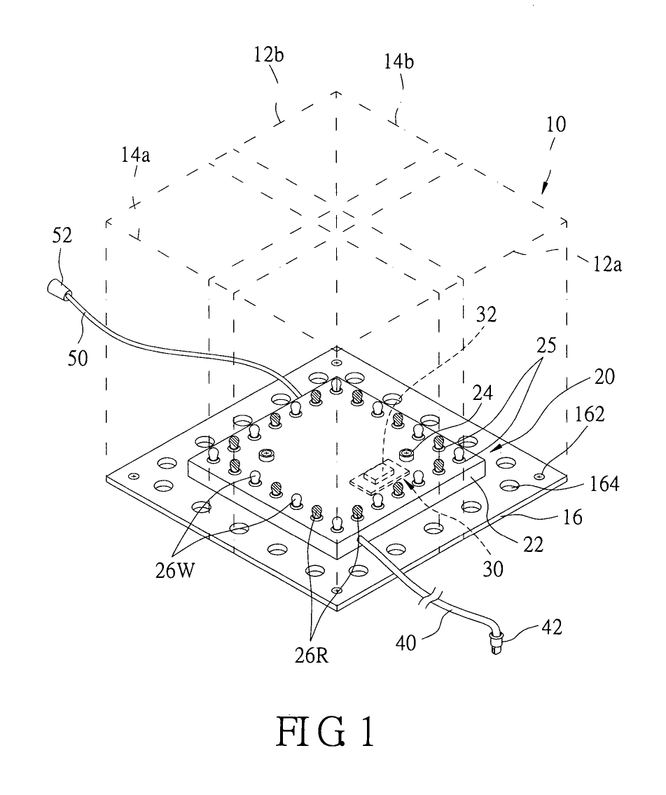

Reference is made to FIG. 1, which is a perspective view of a Christmas ornament of first embodiment according to the present invention. The present invention provides a Christmas ornament, which has a housing 10 and an illuminating device 20. The housing 10 can be worked into different shapes. In this embodiment, the Christmas ornament is a gift box, and is a cube-shaped. But the present invention is not limited by these embodiments and can be applied in other ornament, such as ice cubes.

The housing 10 has a plurality of peripheral walls and a bottom wall 16. In this embodiment, the housing has two pairs of peripheral walls 12a, 12b, 14a, and 14b. The peripheral walls 12a, 12b, 14a, and 14b are made of semitranslucent material, for example plastic, PVC (polyvinyl chloride) or cloth, which are pervious to light and has a well-diffused appearance. The bottom wall 16 is fixed on a bottom of the peripheral walls 12a, 12b, 14a, and 14b, such as being riveted or screwed to the bottom wall 16. The bottom wall 16 can be formed with many holes 164 for reducing weight.

The illuminating device 20 has a light seat 22, which is fixed on the bottom wall 16. In this embodiment, the light seat 22 is screwed on the bottom wall 16 by screws 24. A plurality of light sources 26R, 26W are fixed on the light seat 22, and a control unit 30 is received in the light seat 22. The light sources 26R, 26W could be bulbs, rice lights or LEDs. In this embodiment, the light seat 20 has a plurality of light sockets 25 arranged in a matrix manner, and the light sources 26R, 26W are plugged in the light sockets 25 respectively.

The light sources 26R, 26W could be divided into at least two color groups, such as red, green, blue and white. The control unit 30 is connecting electrically the light sources 26R, 26W and has an IC 32. The IC 32 is used for controlling the color groups (red, white) to illuminate according to a predetermined sequence, such as shining different colors by turns. For example, a red light, a pink light or orange light (resulted by mixing a red light with a white light), and a white light are shined by turns. Therefore, such color-transformation makes the present invention more viewable, brilliant, and attractable and make holiday display shine.

In this embodiment, the light sources 26R, 26W are arrange on a same plane, so that the light sources 26R, 26W are lower and can illuminate an ornament with a bigger area.

In the present invention, the Christmas ornament has a power wire 40 electrically connecting with the illuminating device 20. The power wire 40 has a plug 42 for connecting to electrical power. The Christmas ornament can further has a socket wire 50 electrically connecting with the illuminating device 20. The socket wire 50 extends beyond the housing 10 for supplying electrical power to another Christmas ornament.

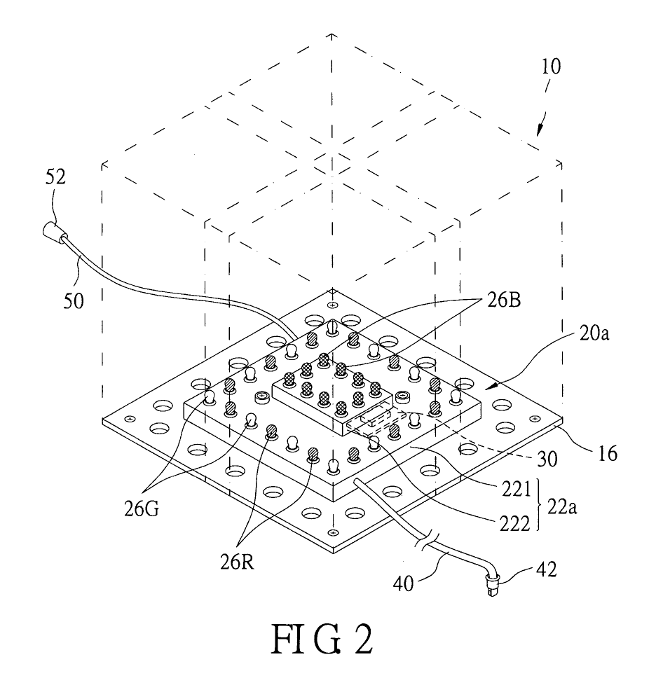

Reference is made to in FIG. 2. A Christmas ornament of second embodiment according to the present invention is shown, which has an illuminating device 20a. The illuminating device 20a has a light seat 22a and a plurality of light sources 26R, 26G, 26B, which represent red, green, and blue lights. The light seat 22a is formed with two step-shaped platforms 221, 222 along a periphery thereof. The light sources 26R, 26G, 26B are fixed on the step-shaped platforms 221, 222 respectively. In other words, two light matrices are provided. In this embodiment, the light sources 26R, 26G, 26B can mix out many color lights, such as yellow, cyan, and magenta light, and provide more color-transforming effectiveness with an well-mixed and gradual-layers light appearance.

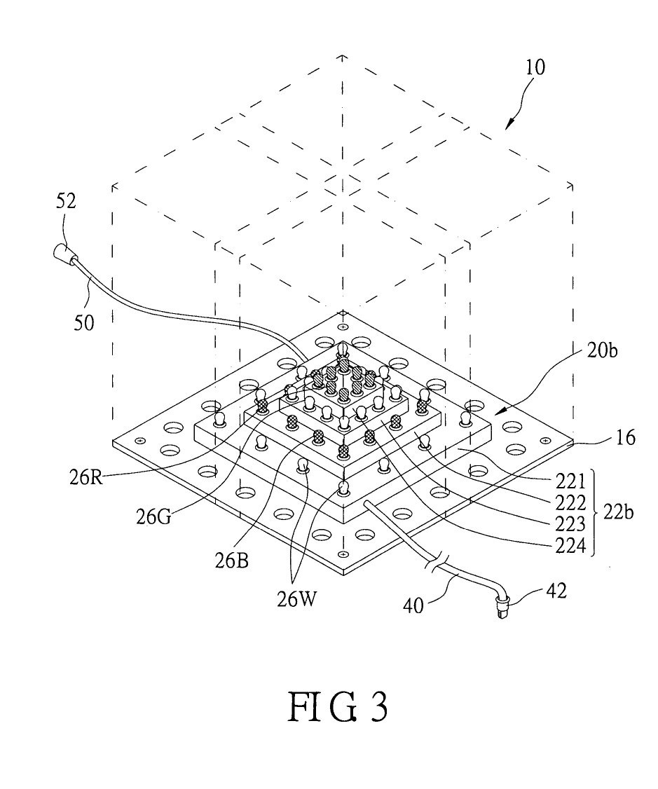

Reference is made to in FIG. 3. A Christmas ornament of third embodiment is shown, which has an illuminating device 20b. The illuminating device 20b has a light seat 22b formed with four step-shaped platforms 221, 222, 223, 224, and a plurality of light sources 26R, 26G, 26B, 26W are fixed on the step-shaped platforms 221, 222,223, 224, respectively. The light source 26W represents white light and can make the Christmas ornament full of more view transformation. This is a preferred embodiment, which can provide a light effectiveness of gradual-layer colors.

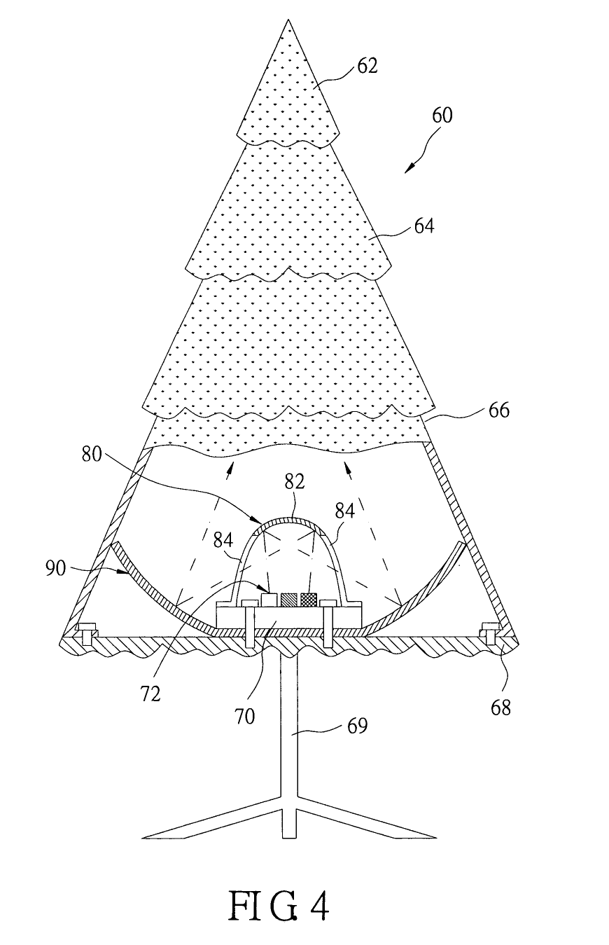

Reference is made to in FIG. 4. A Christmas ornament of fourth embodiment is shown. In this embodiment, the present invention is applied as a Christmas tree and has a housing 60, which is cone-shaped. The housing 60 has a plurality of peripheral walls 62, 64, 66 and a bottom wall 68. The housing 60 has a stand 69 for supporting the Christmas tree. An illuminating device 70 is fixed on the bottom wall 68. A reflective hood 80 is fixed above the illuminating device 70, and a reflective shell 90 is fixed under the illuminating device 70. The illuminating device 70 has a plurality of light sources 72 fixed thereon. The reflective hood 80 has a reflective portion 82 and a plurality of fixing legs 84 that are extending from a peripheral edge of the reflective portion 82. The fixing legs 84 are fixed on the light seat 70. The reflective shell 90 is arc-shaped for upwardly reflecting lights from the reflective hood 80 to an upper portion of the housing 60.

In the fourth embodiment, not only the illuminating device 70 can be fixed in the Christmas tree easily, but also the illuminating device 70 can shine upwardly to an upper portion of the housing 60 with a well-mixed lighting effectiveness.

A summary of the characteristics and advantages of the Christmas ornament of the present invention are as followed:

1. The illuminating device of the present invention can be assembled easily in the Christmas ornament.

2. The present invention can provide color-transforming effectiveness with a well mixed and gradual-layer color light appearance, so that making the Christmas ornament more viewable and attractable.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A Christmas ornament, comprising:
a housing, having a plurality of peripheral walls and a bottom wall, said plurality of peripheral walls made of semitranslucent material and said bottom wall fixed on a bottom of said peripheral walls; and
an illuminating device, having a light seat fixed on said bottom wall, a plurality of light sources fixed on said light seat and a control unit received in said light seat, said plurality of light sources are divided into at least two color groups, and said control unit electrically connecting said plurality of light sources for controlling said color groups to illuminate according to a predetermined sequence.

2. The Christmas ornament as in claim 1, wherein said housing is cube-shaped.

3. The Christmas ornament as in claim 1, wherein said light seat is formed with at least two step-shaped platforms along a periphery thereof, and said light sources are fixed on said step-shaped platforms respectively.

4. The Christmas ornament as in claim 1, wherein said light sources are rice lights or LEDs.

5. The Christmas ornament as in claim 1, wherein said control unit has an IC.

6. The Christmas ornament as in claim 1, further comprising a socket wire electrically connecting with said illuminating device and extending beyond said housing for supplying electrical power to another Christmas ornament.

7. The Christmas ornament as in claim 1, wherein said housing is cone-shaped.

8. The Christmas ornament as in claim 7, further comprising a reflective hood fixed above said illuminating device, and a reflective shell fixed under said illuminating device.

9. The Christmas ornament as in claim 8, wherein said reflective hood has a reflective portion for reflecting lights and a plurality of fixing legs extending from a peripheral edge of said reflective portion, and said fixing legs are fixed on said light seat.

10. The Christmas ornament as in claim 8, wherein said reflective shell 90 is arc-shaped for upwardly reflecting lights from said reflective hood to an upper portion of said housing.

11. The Christmas ornament as in claim 1, wherein said light seat has a plurality of light sockets arranged in a matrix manner, and said light sources plugged in said light sockets respectively.
